(19) United States
(12) Patent Application Publication
(10) Pub. No.: US 2013/0039058 A1
(43) Pub. Date: Feb. 14, 2013

(54) LIGHTING APPARATUS

(71) Applicants: Ji-hoon YUN, Seoul (KR); Byeong-hyeon YU, Seoul (KR); Tetsuo ARIYOSHI, Suwon-si (KR); Cheon-ho PARK, Suwon-si (KR)

(72) Inventors: Ji-hoon YUN, Seoul (KR); Byeong-hyeon YU, Seoul (KR); Tetsuo ARIYOSHI, Suwon-si (KR); Cheon-ho PARK, Suwon-si (KR)

(73) Assignee: SAMSUNG ELECTRONICS CO., LTD., Suwon-si (KR)

(21) Appl. No.: 13/570,597

(22) Filed: Aug. 9, 2012

(30) Foreign Application Priority Data
Aug. 9, 2011 (KR) 10-2011-0079151

(51) Int. Cl. F21V 3/02; F21V 23/00; F21V 29/00; F21V 3/00; F21V 7/10

(52) U.S. Cl. 362/235; 362/351; 362/361

(57) ABSTRACT

Provided is a lighting apparatus including: a plurality of light-emitting devices; a mounting portion on which the plurality of light-emitting devices is disposed; and a light guide cover which guides light emitted from the plurality of light-emitting devices to the outside.

### CROSS-REFERENCE TO RELATED APPLICATION

This application claims priority from Korean Patent Application No. 10-2011-0079151, filed on Aug. 9, 2011 in the Korean Intellectual Property Office, the disclosure of which is incorporated herein in its entirety by reference.

### BACKGROUND

1. Field

The present disclosure relates to a lighting apparatus, and more particularly, to a lighting apparatus having a light distribution characteristic of a wide angle.

2. Description of the Related Art

Light-emitting diodes (LEDs) are semiconductor devices including a light-emitting source through a PN junction of a compound semiconductor so as to display various light colors. Recently, a blue LED and a ultra-violet (UV) LED formed using nitride having excellent physical and chemical characteristics have appeared. Also, white light or other solid color light may be formed using the blue or UV LED and a fluorescent material, and thus light-emitting devices are being more widely used. LEDs have a long lifespan, may be made small and light, and may be driven at a low voltage. Also, the LEDs are resistant to impact and vibration, do not need a preheating time and complicated driving, and may be packaged in various forms. Thus, the LEDs may be used for a variety of applications.

Recently, LEDs may be used not only as backlights of display apparatuses, but also as high power and high efficiency light sources employed in various lighting apparatuses such as general illuminations, decorative illuminations, local illuminations, and the like.

However, the LEDs are devices that radiate light in only a forward direction and not in all directions, and thus a lighting apparatus using the LEDs is greatly different from a related art bulb in terms of a light distribution characteristic. Accordingly, the supply of lighting apparatuses using LEDs is hampered because of their light distribution characteristic and visibility that are greatly different from those of the related art bulb.

### SUMMARY

Provided is a lighting apparatus capable of increasing an irradiation angle of light emitted from a light source.

Additional aspects will be set forth in part in the description which follows and, in part, will be apparent from the description, or may be learned by practice of the presented embodiments.

According to an aspect of an exemplary embodiment, there is provided a lighting apparatus including: a plurality of light-emitting devices; a mounting portion on which the plurality of light-emitting devices is disposed; and a light guide cover which guides light emitted from the plurality of light-emitting devices to the outside.

The light guide cover may include an internal surface, an external surface, and a connecting surface for connecting the external surface and the internal surface and facing the plurality of light-emitting devices.

A groove may be formed in the connecting surface, and at least some of the light-emitting devices may be disposed in the groove.

A concave-convex surface may be formed on the connecting surface.

The concave-convex surface may be formed by combining at least one of a concave shape and a convex shape, each of which has an inclined side surface.

The light guide cover may include a first light guide cover which is dome-shaped and disposed on the mounting portion.

The light guide cover may include a second light guide cover which is tube-shaped and disposed under the mounting portion.

The lighting apparatus may further include a reflecting portion disposed on the internal surface of the light guide cover and reflecting light to the external surface of the light guide cover.

The lighting apparatus may further include a diffusion portion disposed on an external surface of the light guide cover and mixing the light.

The diffusion portion may be formed of a diffusion material and a resin material filled with phosphor.

The lighting apparatus may further include a heat radiating portion for radiating heat generated by the light-emitting device.

The heat radiating portion may include a first heat radiating portion including: a plurality of heat radiating fins arranged in a radial shape based on a central axis of the lighting apparatus; and a plurality of louver fins that are each cut from the heat radiating fin to bend.

The heat radiating portion may further include a second heat radiating portion for connecting the first heat radiating portion and the mounting portion.

A cross-section contacting the mounting portion of the second heat radiating portion may be smaller than a cross-section of the mounting portion.

The lighting apparatus may further include a first printed circuit board (PCB) substrate which is disposed on the mounting portion and on which at least some of the light-emitting devices are disposed.

The first PCB substrate may have a circular shape.

The at least some of the light-emitting devices may be disposed on edge portions of the PCB substrate.

The lighting apparatus may further include a second PCB substrate which is disposed under the mounting portion and on which at least some of the light-emitting devices are disposed.

The second PCB substrate may have a ring shape.

The light-emitting devices may include first and second light-emitting devices disposed adjacent on the same substrate, and the first and second light-emitting devices may be connected to each other by using a metal layer coated from a portion of the first light-emitting device across a portion on the substrate to a portion of the second light-emitting device.

According to an aspect of another exemplary embodiment, there is provided a light guide cover for guiding light emitted from a lighting apparatus to an outside, the light guide cover including: an internal surface; an external surface opposite the internal surface; and a light-emitting device accommodating space which is provided between the internal surface and the external surface to accommodate at least one light-emitting device.

### BRIEF DESCRIPTION OF THE DRAWINGS

These and/or other aspects will become apparent and more readily appreciated from the following description of exemplary embodiments, taken in conjunction with the accompanying drawings in which:

FIGS. 1 to 5 are views illustrating a lighting apparatus according to an exemplary embodiment;

FIGS. 6 to 10 are cross-sectional views illustrating a structure of a light-emitting device according to an exemplary embodiment;

FIG. 11 is a view illustrating an internal structure of a first heat radiating portion according to an exemplary embodiment; and

FIG. 12 is a cross-sectional side view illustrating a lighting apparatus according to another exemplary embodiment.

### DETAILED DESCRIPTION OF EXEMPLARY EMBODIMENTS

Exemplary embodiments will now be described more fully with reference to the accompanying drawings, in which exemplary embodiments are shown. Exemplary embodiments may, however, be embodied in many different forms, and should not be construed as being limited to exemplary embodiments set forth herein. Rather, these exemplary embodiments are provided so that this disclosure will be thorough and complete, and will fully convey concepts of exemplary embodiments to one of ordinary skill in the art. In the drawings, the thicknesses of layers and regions are exaggerated for clarity.

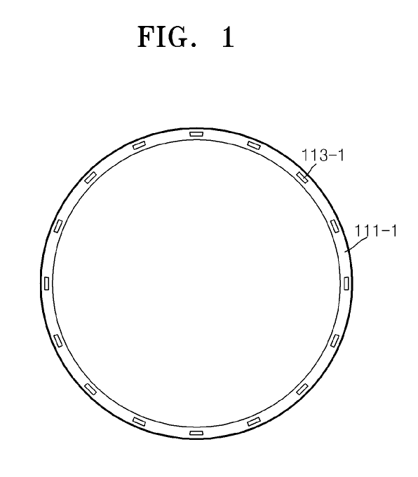

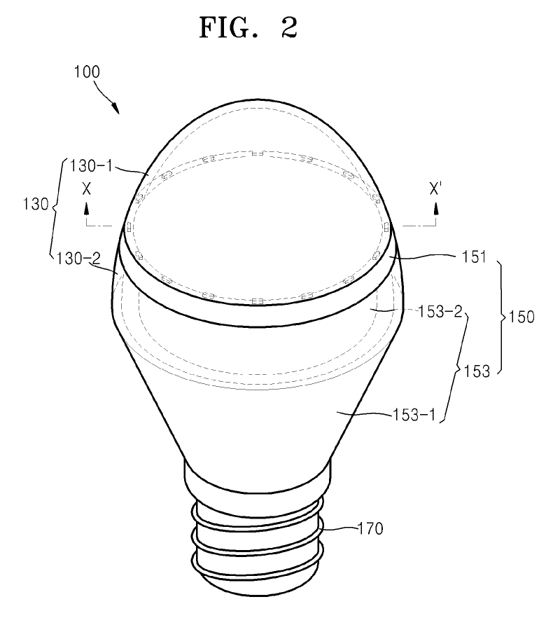

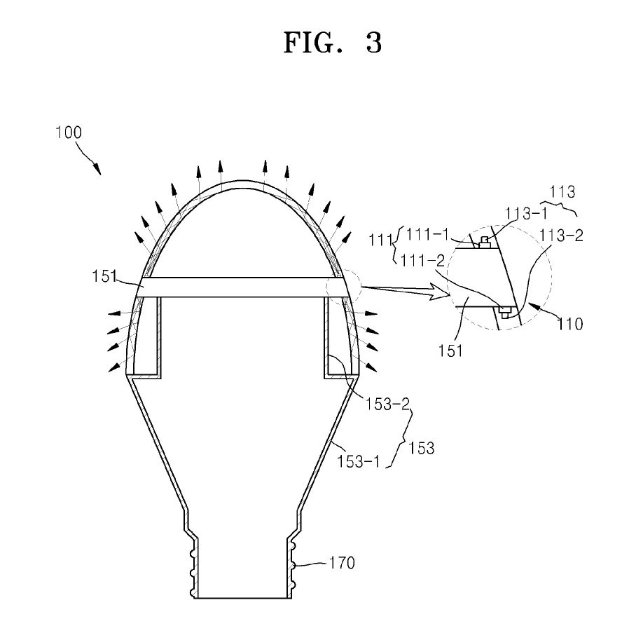

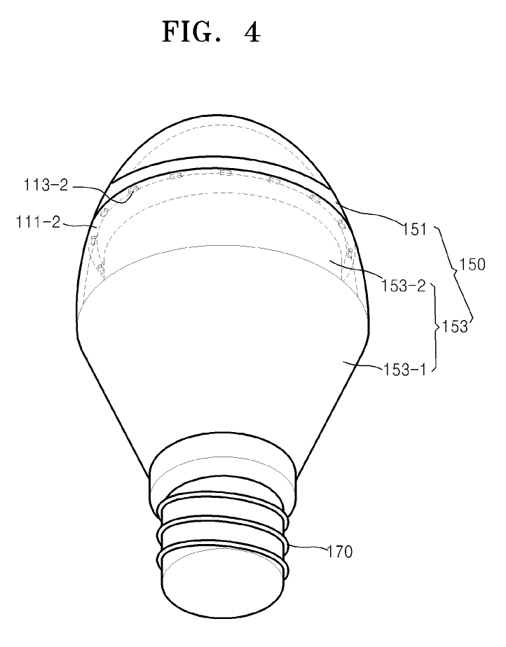

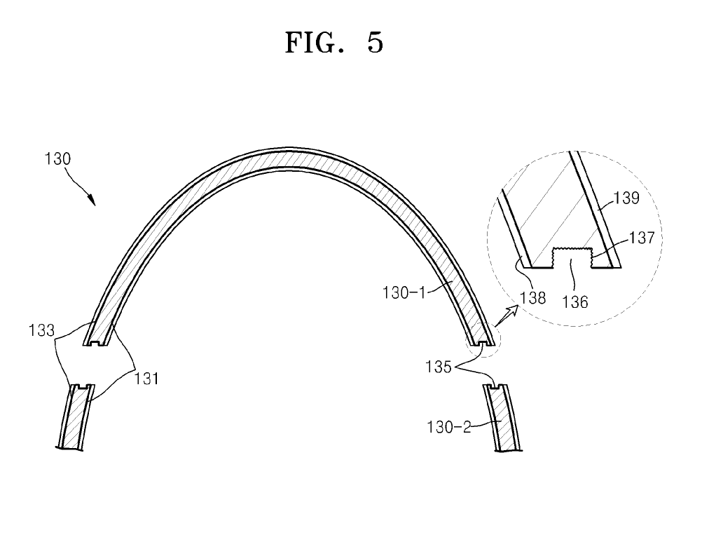

FIG. 1 is a cross-sectional front view of a lighting apparatus 100, according to an exemplary embodiment. FIG. 2 is a perspective view of the lighting apparatus 100. FIG. 3 is a cross-sectional side view of the lighting apparatus 100. FIG. 4 is a bottom perspective view of the lighting apparatus 100. FIG. 5 is a cross-sectional view of a light guide cover 130 included in the lighting apparatus 100.

Referring to FIGS. 1 to 5, the lighting apparatus 100 may include a light-emitting module 110 (e.g., light emitting diode (LED)) that emits light, the light guide cover 130 facing the light-emitting module 110 and guiding light to the outside, and a body portion 150 supporting the light-emitting module 110 and the light guide cover 130.

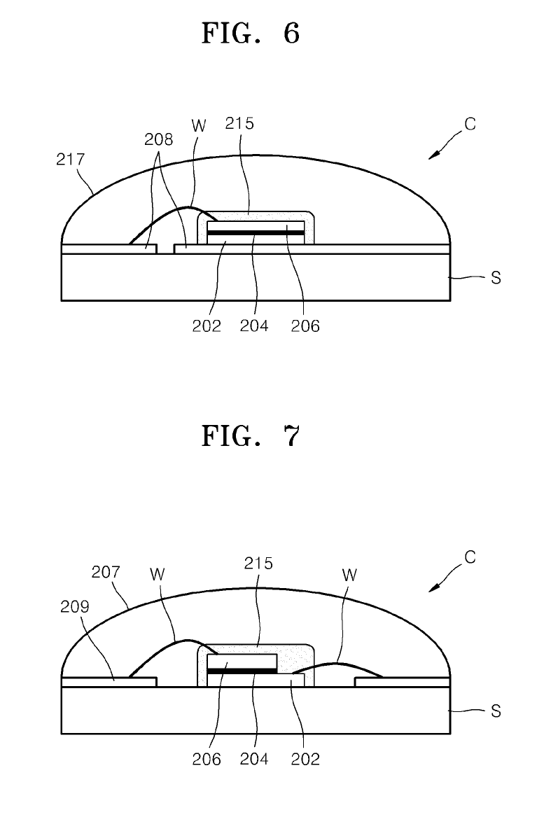

Referring to FIG. 2, the body portion 150 forms an exterior of the lighting apparatus 100 and is provided to dispose the light-emitting module 110. The shape of the body portion 150 is not limited to that illustrated in FIG. 2. For example, the shape of the body portion 150 may vary in one or more other exemplary embodiments according to, for example, requirements or design preferences for the lighting apparatus 100. The body portion 150 may include a metal material having an excellent thermal conductivity, such as aluminum (Al), in order to effectively radiate heat generated by the light-emitting module 110, for example, from the light-emitting device C (see FIGS. 6-10).

The body portion 150 may include a mounting portion 151 on which the light-emitting module 110 is disposed and a heat radiating portion 153 for radiating heat generated by the light-emitting module 110.

The mounting portion 151 may have a flat panel shape. The light-emitting module 110 may be disposed on the mounting portion 151, under the mounting portion 151, or both on and under the mounting portion 151. A side surface of the mounting portion 151 may be inclined in correspondence to a curve of the light guide cover 130. A cross-section of the mounting portion 151 may have a circular shape. However, one or more other exemplary embodiments are not limited thereto, and the cross-section thereof may have any other shape, e.g., a polygonal shape such as a quadrilateral shape.

The heat radiating portion 153 may include a first heat radiating portion 153-1 configured to have a heat sink structure, and a second heat radiating portion 153-2 for connecting the mounting portion 151 and the first heat radiating portion 153-1.

A socket 170 connected to a power source (not shown) may be provided at an end of the first heat radiating portion 153-1. A structure of the first heat radiating portion 153-1 will be described below.

A first end of the second heat radiating portion 153-2 contacts a lower surface of the mounting portion 151, and a second end thereof contacts an upper surface of the first heat radiating portion 153-1. The second heat radiating portion 153-2 has a cross-section with a circular shape in the present exemplary embodiment, and may have a predetermined thickness. Also, the cross-section of the first end of the second heat radiating portion 153-2 may be smaller than a cross-section of a mounting plate. Accordingly, the first end of the second heat radiating portion 153-2 may be disposed in the center portion of the lower surface of the mounting portion 151.

Referring to FIGS. 1, 3, and 4, the light-emitting module 110 may include a printed circuit board (PCB) substrate 111 disposed in the body portion 150 and a light-emitting device portion 113 including at least one light-emitting device C disposed on the PCB substrate 111. The PCB substrate 111 may include a first PCB substrate 111-1 disposed on the mounting portion 151 and a second PCB substrate 111-2 disposed under the mounting portion 151. The first PCB substrate 111-1 may have a circular shape or a ring shape, and the second PCB substrate 111-2 may have a ring shape, though it is understood that one or more other exemplary embodiments are not limited thereto.

The light-emitting device portion 113 may include a first light-emitting device portion 113-1 disposed on the first PCB substrate 111-1 and a second light-emitting device portion 113-2 disposed on the second PCB substrate 111-2. The light-emitting device C (e.g., light emitting diode) included in the first and second light-emitting device portions 113-1 and 113-2 may be a top view type light-emitting device. That is, the light-emitting device C included in the first light-emitting device portion 113-1 may emit light upwards from the mounting portion 151, and the light-emitting device C included in the second light-emitting device portion 113-2 may emit light downwards from the mounting portion 151.

Referring to FIGS. 2 and 5, the light guide cover 130 surrounds the light-emitting module 110 and may have a globe shape. The light guide cover 130 guides light emitted from the light-emitting module 110 to the outside. The light guide cover 130 may be formed of a transparent material having a constant refractive index, for example, polymethyl methacrylate (PMMA), poly olefin, or polycarbonate which is an acrylic resin.

The light guide cover 130 may include an internal surface 131 disposed inside the lighting apparatus 100, an external surface 133 exposed to the outside of the lighting apparatus 100, and at least one connecting surface 135 for connecting the internal surface 131 and the external surface 133. The internal surface 131 and the external surface 133 may have the same shape. A groove 136 may be provided in the at least one connecting surface 135, so as to be inside the light guide cover 130, and the light-emitting device C may be disposed in the groove 136. A size of the groove 136 corresponds to that of the light-emitting device C. Also, a concave-convex surface 137 may be formed in the groove 136. A concave-convex surface 137 may be formed in the groove 136 by combining at least one of a concave shape and a convex shape, each of which has an inclined surface. The light emitted from the light-emitting module 110 may be incident on the light guide cover 130 via the concave-convex surface 137 at various angles.

In the present exemplary embodiment, the groove 136 is provided in such a way that the light-emitting device C is disposed in the connecting surface 135 facing the light-emitting device C. However, one or more other exemplary embodiments are not limited thereto, and the groove 136 may be provided in such a way that the light-emitting device C is disposed in the PCB substrate 111.

A reflecting portion 138 may further be provided on the internal surface 131 of the light guide cover 130, wherein the reflecting portion 138 may reflect light to the external surface 133 of the light guide cover 130. The reflecting portion 138 may have a film shape using a material having a high reflectivity. Examples of the material may include a metal, a reflective paint, and the like. The metal may be a high reflective metal having a high reflectivity of more than 90%, and the metal may include silver (Ag), aluminium (Al), gold (Au), copper (Cu), palladium (Pd), platinum (Pt), and rhodium (Rd), or a combination thereof. The reflecting portion 138 may be formed by deposition. Alternatively, the reflective paint may include a reflective material including titanium dioxide (TiO2), zinc oxide (ZnO), and calcium carbonate (CaCo3), or a combination thereof. Coating of the reflective paint may be performed by using a spray, a roller, or the like. Also, the reflecting portion 138 may be formed by coating the reflective paint on the internal surface 131 of the light guide cover 130 and then depositing the high reflective metal thereon.

In addition, a diffusion portion 139 for mixing and diffusing light may further be provided on the external surface 133 of the light guide cover 130. The diffusion portion 139 may be formed by coating a diffusion material on the external surface 133. A micro-pattern (not shown) may be provided on at least a part of the external surface 133 of the light guide cover 130. The micro-pattern diffuses light. In this case, a diffusion material may not be coated on the light guide cover 130. Alternatively, the diffusion portion 139 may be include a diffusion material and a resin material filled with phosphor.

Also, the light guide cover 130 may include a first light guide cover 130-1 for guiding light emitted from the first light-emitting device portion 113-1 and a second light guide cover 130-2 for guiding light emitted from the second light-emitting device portion 113-2 according to where the light guide cover 130 is disposed. The first light guide cover 130-1 may have a dome shape, and the second light guide cover 130-2 may have a tube shape. For example, the second light guide cover 130-2 may have a predetermined radius of curvature and may have a cylindrical shape. The first light guide cover 130-1 may face the first light-emitting device portion 113-1 and may be disposed on the mounting portion 151. An upper connecting surface of the second light guide cover 130-2 may face the second light-emitting device portion 113-2 and may be disposed under the mounting portion 151, and a lower connecting surface may be disposed on the first heat radiating portion 153-1.

As described above, light may enter the light guide cover 130, and thus the light may be uniformly emitted to the outside and a light distribution range may be extended.

Hereinafter, a light-emitting device C used in a lighting apparatus 100 according to an exemplary embodiment will be described.

FIG. 6 is a cross-sectional view illustrating a structure of the light-emitting device C according to an exemplary embodiment.

The light-emitting device C includes a light-emitting chip including a first type semiconductor layer 202, an active layer 204, and a second type semiconductor layer 206 that are disposed on a substrate S, and a phosphor layer 215 coated around the light-emitting chip.

The substrate S may be a resin substrate, for example, an FR4 substrate or an FR5 substrate, though it is understood that one or more other exemplary embodiments are not limited thereto. For example, according to another exemplary embodiment, the substrate S may include ceramic or glass fiber material.

The first type semiconductor layer 202, the active layer 204, and the second type semiconductor layer 206 may be formed of a compound semiconductor. For example, the first type semiconductor layer 202 and the second type semiconductor layer 206 may have a composition of a nitride semiconductor, that is, AlxInyGa 1-x-y)N (0≦x≦1, 0≦y≦1, 0x+y≦1), and may be doped with an n-type impurity and a p-type impurity, respectively. The active layer 204 between the first type semiconductor layer 202 and the second type semiconductor layer 206 emits light having a predetermined energy by the recombination of electrons and holes and may have a structure in which a plurality of layers each having a composition of InxGa1-xN (0≦x≦1) are stacked to control a band-gap energy according to Indium content. In this case, the active layer 204 may have a multi-quantum well (MQW) structure in which a quantum barrier layer and a quantum well layer are alternately stacked, for example, an InGaN/GaN structure, wherein the Indium content may be controlled to emit blue light.

The phosphor layer 215 may include a phosphor that absorbs blue light and excites red light and a phosphor that absorbs blue light and excites green light. Examples of the phosphor that excites red light may include a nitride-based phosphor having a compositional formula of MAlSiNx:Re (1≦x≦5), a sulfide-based phosphor having a compositional formula of MD:Re, and the like, wherein M is at least one of Ba, Sr, Ca, and Mg, D is at least one of S, Se, and Te, and Re is at least one of Eu, Y, La, Ce, Nd, Pm, Sm, Gd, Tb, Dy, Ho, Er, Tm, Yb, Lu, F, Cl, Br, and I. Also, examples of the phosphor that excites green light may include a silicate-based phosphor having a compositional formula of M2SiO4:Re, a sulfide-based phosphor having a compositional formula of MA2D4:Re, a phosphor having a compositional formula of β-SiAlON:Re, an oxide-based phosphor having a compositional formula of MA′2O4:Re′, and the like, wherein M may be at least one of Ba, Sr, Ca, and Mg, A may be at least one of Ga, Al, and In, D may be at least one of S, Se, and Te, A′ may be at least one of Sc, Y, Gd, La, Lu, Al, and In, Re may be at least one of Eu, Y, La, Ce, Nd, Pm, Sm, Gd, Tb, Dy, Ho, Er, Tm, Yb, Lu, F, Cl, Br, and I, and Re′ may be at least one of Ce, Nd, Pm, Sm, Tb, Dy, Ho, Er, Tm, Yb, F, Cl, Br, and I.

According to the present exemplary embodiment, the blue light emitted from the active layer 204 is partially changed into red light and green light, and thus blue light, red light, and green light are mixed, thereby emitting white light.

An electrode pattern portion 208 divided into two portions is formed on the substrate S. The electrode pattern portion 208 may include a conductive material, such as Cu, Pd, Ag, or Ni/Au, and may be formed by plating. The first type semiconductor layer 202 is bonded to a portion of the electrode pattern portion 208, and the second type semiconductor layer 206 is connected to the other portion of the electrode pattern portion 208 using a wire W.

Also, a light guide cover layer 217 having a lens shape may further be provided so as to protect the light-emitting chip and to control the directivity of light emitted from the light-emitting chip. The light guide cover layer 217 may be formed of a transparent material such as resin. A shape of the light guide cover layer 217 is not limited to that illustrated in FIG. 6 in one or more other exemplary embodiments. For example, the light guide cover layer 217 may be flat to protect the light-emitting chip and not to serve as a lens.

FIG. 7 is a cross-sectional view illustrating a structure of a light-emitting device C according to another exemplary embodiment. The light-emitting device C of the present exemplary embodiment is different from that illustrated in FIG. 6 in terms of a structure of an electrode. That is, a light-emitting chip including a first type semiconductor layer 202, an active layer 204, and a second type semiconductor layer 206 has a structure etched in a mesa shape so as to partially expose a region of the first type semiconductor layer 202. The exposed region of the first type semiconductor layer 202 is connected to a portion of the electrode pattern portion 209 using a wire W, and the second type semiconductor layer 206 is connected to the other portion of the electrode pattern portion 208 using a wire W.

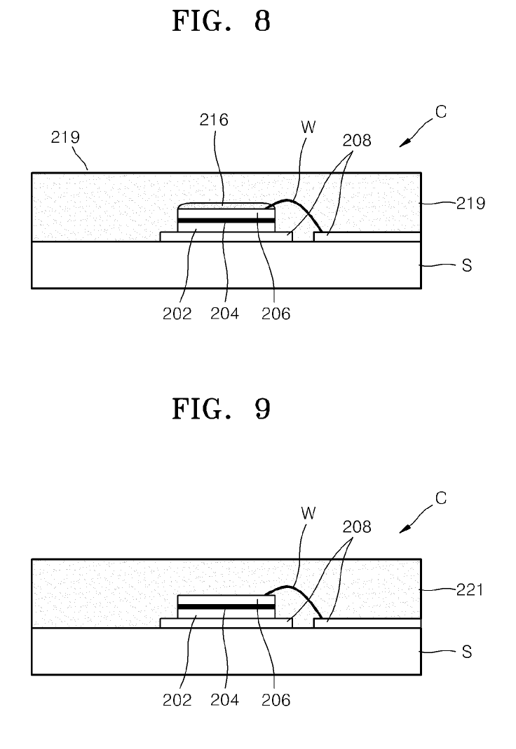

FIG. 8 is a cross-sectional view illustrating a structure of a light-emitting device C according to another exemplary embodiment. The light-emitting device C of the present exemplary embodiment has a structure in which a phosphor layer 216 is coated only on a light-emitting chip. In FIG. 8, a light guide cover layer 219 is flat. However, one or more other exemplary embodiments are not limited thereto, and the light guide cover layer 219 may have a lens shape so as to control the directivity of light emitted from the light-emitting chip.

FIG. 9 is a cross-sectional view illustrating a structure of a light-emitting device C according to another exemplary embodiment. The light-emitting device C of the present exemplary embodiment is different from the light-emitting device C illustrated in FIG. 8 in that the light-emitting device C of the present exemplary embodiment has a structure in which a phosphor layer is not coated on a light-emitting chip and a light guide cover layer 221 is formed of a transparent material mixed with phosphor, e.g., a resin material. A shape of the light guide cover layer 221 may be a lens shape so as to control the directivity of light emitted from the light-emitting chip.

The light-emitting devices C illustrated in FIGS. 6 to 9 are individually formed as packages in which the light-emitting device C is disposed on the substrate S and a semiconductor layer is bonded, using a wire, to an electrode pattern portion formed on the substrate S. Also, adjacent light-emitting devices C may be connected to each other in series, in parallel, or in a combination of series and parallel according to a shape of the electrode pattern portion formed on the substrate S.

Alternatively, in the light-emitting module 110, the light-emitting devices C may be individually connected to one another by using a connecting member having a metal layer shape instead of using a wire, and all the light-emitting devices C may be included one package.

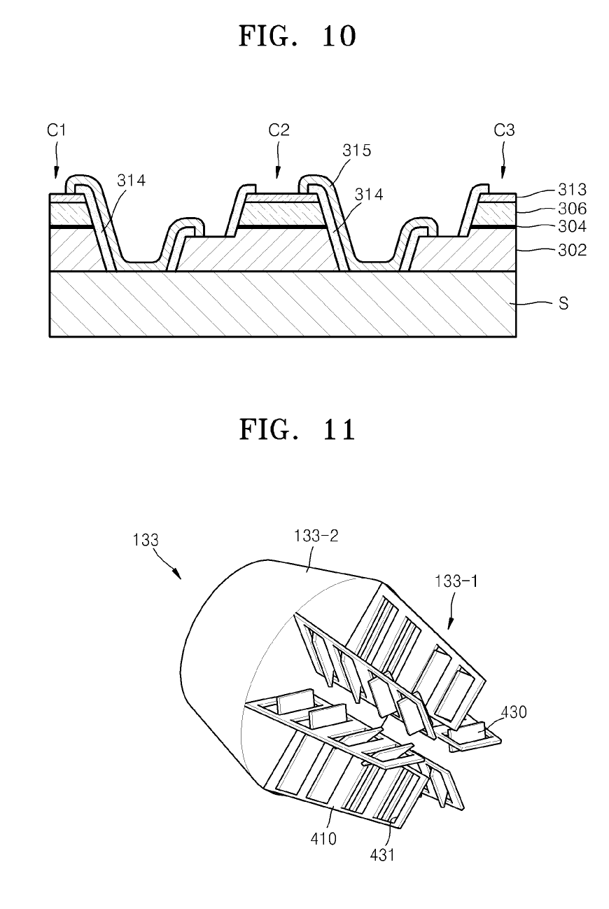

FIG. 10 is a view illustrating a plurality of light-emitting devices C connected to one another by using a metal layer, according to an exemplary embodiment.

Referring to FIG. 10, the plurality of light-emitting devices C1, C2, C3 may each be obtained by dividing a semiconductor multi-layer in which a first type semiconductor layer 302, an active layer 304, and a second type semiconductor layer 306 are sequentially stacked on a substrate S by performing an isolation process or may be obtained by growing the first type semiconductor layer 302, the active layer 304, and the second type semiconductor layer 306 that are originally isolated from one another.

Adjacent light-emitting devices C1, C2, C3 may be connected to each other via a connecting portion 315. That is, the connecting portion 315 may be a metal layer that is coated from a portion of the light-emitting device C1, C2, C3 across a portion on the substrate S to a portion of the adjacent light-emitting device C1, C2, C3. In each of the light-emitting devices C1, C2, C3, the first type semiconductor layer 302 has a partially exposed region through mesa etching, and the connecting portion 315 is a metal layer that is coated from a portion of the exposed region of the first type semiconductor layer 302 across a portion on the substrate S to the second type semiconductor layer 306 of the adjacent light-emitting device C1, C2, C3.

In FIG. 10, if the plurality of light-emitting devices C1, C2, C3 are connected to one another in series, first and second bonding pads (not shown) may be respectively formed on the light-emitting devices C1, C2, C3 disposed at both ends so as to be connected to respective electrodes having the corresponding polarities of the light-emitting devices C1, C2, C3 disposed at both ends.

A transparent electrode 313 including a transparent conductive material such as indium tin oxide (ITO) or zinc oxide (ZnO) may be provided on the second type semiconductor layer 306 and may perform ohmic contact and current distribution functions. Also, an insulating layer 314 may be provided on side surfaces of each light-emitting device C1, C2, C3 so as to prevent the connecting portion 315 from contacting an undesired region of the corresponding light-emitting device C1, C2, C3. The insulating layer 314 may include a material such as silicon oxide or silicon nitride. The insulating layer 314 may be used as a passivation layer provided on the entire side surfaces of the light-emitting device C1, C2, C3, as illustrated in FIG. 10.

As described above with reference to FIG. 10, a wire for electrically connecting the light-emitting devices C1, C2, C3 is not used, thereby reducing a possibility of a short circuit and improving facilitating a wire process.

Also, although not shown in FIG. 10, a light guide cover layer for protecting the light-emitting devices C1, C2, C3 may further be provided, and the light guide cover layer may have a lens shape so as to control the directivity of emitted light as the occasion demands. In addition, a phosphor layer (not shown) may further be provided to convert the color of emitted light, and the light guide cover layer may include a material including phosphor.

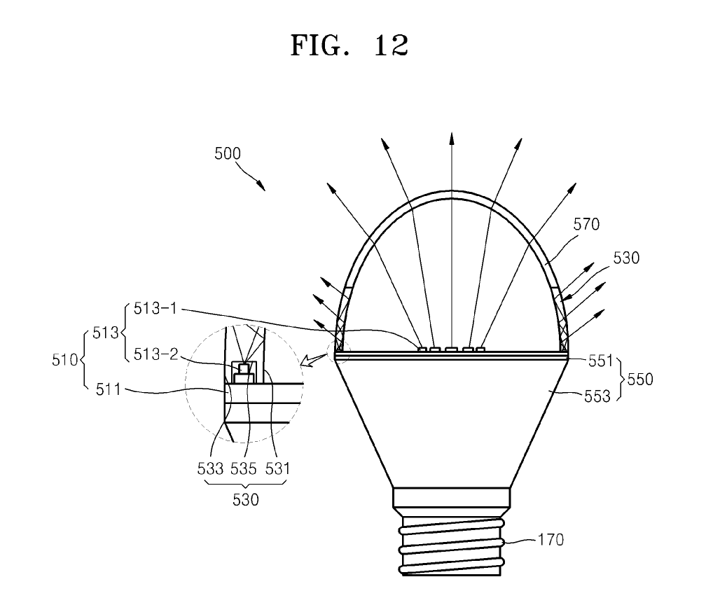

FIG. 11 is a view illustrating an internal structure of a first heat radiating portion 153-1 according to an exemplary embodiment.

As illustrated in FIG. 11, the first heat radiating portion 153-1 may include a plurality of heat radiating fins 410 and a plurality of louver fins 430.

The heat radiating fins 410 may be arranged in a radial shape in a circumferential direction based on a position corresponding to a central portion of the light-emitting module 110. Each of the heat radiating fins 410 may have a rectangular panel shape, and a side surface of the heat radiating fin 410 may contact the second heat radiating portion 153-2 and may extend in a lengthwise direction from the second heat radiating portion 153-2.

The heat radiating fin 410 may increase a surface area contacting air, and thus the heat radiating fin 410 may induce high temperature heat, which is transferred from the light-emitting device C to the second heat radiating portion 153-2, to be radiated to the outside. In a radial structure of the heat radiating fins 410, a density of a central portion of the radial structure is lower than that of an outer portion that is opened, and thus heat may be rapidly radiated by a principle in which high temperature heat moves from a high density portion to a low density portion. The heat radiating fin 410 may include a metal material having an excellent thermal conductivity, for example, Al.

The louver fin 430 may be cut from the heat radiating fin 410 to bend. The plurality of louver fins 430 may be in a lengthwise direction of the heat radiating fin 410. The louver fins 430 may be bent to be opposite to each other based on a central portion of the lengthwise direction of the heat radiating fin 410. A vent 431 is provided by the louver fin 430, and thus high temperature heat may be rapidly radiated to the outside via the louver fins 430 and the vents 431 by a convection phenomena.

The above-described heat radiating fins 410 and the louver fins 430 may be mass-produced by performing a press process using a thin plate. Thus, the heat radiating fins 410 and the louver fins 430 have a lower manufacturing cost and lighter weight than a related art heat radiating fin and a louver fin manufactured through extruding.

FIG. 12 is a cross-sectional side view illustrating a lighting apparatus 500 according to another exemplary embodiment.

Referring to FIG. 12, the lighting apparatus 500 may include a light-emitting module 510 that emits light, a light guide cover 530 having a tube shape and guiding light emitted from a portion of the light-emitting module 510 to the outside, and a body portion 550 supporting the light-emitting module 510 and the light guide cover 530. The lighting apparatus 500 may further include a transmitting cover 570 for emitting light that is emitted from the rest of the portions of the light-emitting module 510 to the outside.

The body portion 550 may include a mounting portion 551 on which the light-emitting module 510 is disposed and a heat radiating portion 553 for radiating heat generated by the light-emitting module 510.

The mounting portion 551 may have a flat panel shape. The light-emitting module 510 may be disposed on the mounting portion 551. A cross-section of the mounting portion 551 may have a circular shape or a polygonal shape such as a quadrilateral shape. The heat radiating portion 553 may be configured to have a heat sink structure.

The light-emitting module 510 may include a PCB substrate 511 disposed in the body portion 550 and a light-emitting device portion 513 including at least one light-emitting device C disposed on the PCB substrate 511. The PCB substrate 511 may be disposed on the mounting portion 551 and may have a circular shape.

The light-emitting device portion 513 may include a plurality of first light-emitting device portions 513-1 disposed on a central portion of the PCB substrate 511 and a plurality of second light-emitting device portions 513-2 respectively disposed on edge portions of the PCB substrate 511. The light-emitting device C may be a top view type light-emitting device. That is, the light-emitting device C may emit light upward from the mounting portion 551.

The plurality of first light-emitting device portion 513-1 may include a plurality of top view type light-emitting devices, respectively. However, a required or desired amount of light is emitted from one light-emitting device C, the light-emitting device portion 513 may include only one light-emitting device C. When the first light-emitting device portion 513-1 includes a plurality of light-emitting devices C, one light-emitting device C is disposed on a central portion of the mounting portion 551 and the rest of the light-emitting devices C may be disposed on the central portion of the mounting portion 551 to be spaced apart form one another at predetermined intervals, wherein the light-emitting device C may be formed in a ring shape. The second light-emitting device portions 513-2 may be respectively formed at both edge portions of the PCB substrate 511 to be spaced apart from each other at a predetermined interval, wherein the second light-emitting device portion 513-2 may be formed in a ring shape.

The light guide cover 530 guides the light emitted from the light guide cover 530 to the outside. The lighting apparatus 500 may include an internal surface 531, an external surface 533, and a connecting surface 535 for connecting the internal surface 531 and the external surface 533. The internal surface 531 and the external surface 533 may have the same shape.

A reflecting portion (not shown) for reflecting light to the external surface 533 of the light guide cover 530 may further be provided on the internal surface 531 of the light guide cover 530. Also, a diffusion portion (not shown) for mixing and diffusing light may further be provided on the external surface 533 of the light guide cover 530. In the connecting surface 535 of the light guide cover 530, an upper connecting surface may contact the transmitting cover 570 and a lower connecting surface may face the second light-emitting device portion 513-2. A groove (not shown) may be provided in the connecting surface 535 of the light guide cover 530 to dispose the light-emitting device C in the groove, and a concave-convex surface (not shown) may be provided in the groove. The transmitting cover 570 emits light emitted from the first light-emitting device portion 513-1 to the outside. The transmitting cover 570 may be coated or include a diffusion material so as to effectively diffuse the light emitted from the first light-emitting device portion 513-1. The transmitting cover 570 may include a diffusion sheet spaced apart from the first light-emitting device portion 513-1 at a predetermined interval. The material of the transmitting cover 570 may be transparent plastic, glass, or translucent plastic including poly carbonate (PC), poly methyl methacrylate (PMMA), acrylic, or the like. The material of the transmitting cover 570 may be a transparent material mixed with a diffusion material.

Also, a micro-pattern (not shown) may be provided on at least one surface of the transmitting cover 570. The micro-pattern provided on at least one surface of the transmitting cover 570 may diffuse light. In this case, the transmitting cover 570 may include a transparent material that is mixed or not mixed with a diffusion material.

In addition, a phosphor may further be mixed with a material to form the light guide cover 530 and the transmitting cover 570 so as to promote color change of light emitted from the first light-emitting device portion 513-1.

The transmitting cover 570 may face the light guide cover 530 at a position corresponding to an irradiation angle of the first light-emitting device portion 513-1 so as to emit the light emitted from the first light-emitting device portion 513-1 to the outside. For example, if the irradiation angle of the first light-emitting device portion 513-1 is 120 degrees, a circumferential angle of the transmitting cover 570 may be 120 degrees.

The lighting apparatus 100 according to an exemplary embodiment includes the dome-shaped first light guide cover 130-1 and the tube-shaped second light guide cover 130-2, and the lighting apparatus 500 of another exemplary embodiment includes the dome-shaped transmitting cover 570 and the tube-shaped light guide cover 530. However, it is understood that one or more other exemplary embodiments are not limited thereto. For example, according to another exemplary embodiment a lighting apparatus may include a single dome-shaped light guide cover.

A lighting apparatus 100 according to exemplary embodiments uses a light guide cover for guiding light and thus may have a light distribution characteristic of a wide angle.

The lighting apparatus may uniformly emit light by the light guide cover for guiding the light.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

What is claimed is:

1. A lighting apparatus comprising:
a plurality of light-emitting devices;
a mounting portion on which the plurality of light-emitting devices is disposed; and
a light guide cover which guides light emitted from the plurality of light-emitting devices to an outside.

2. The lighting apparatus of claim 1, wherein the light guide cover comprises an internal surface, an external surface, and a connecting surface which connects the external surface and the internal surface and faces the plurality of light-emitting devices.

3. The lighting apparatus of claim 2, wherein the connecting surface includes a groove, and at least one of the plurality of light-emitting devices is disposed in the groove.

4. The lighting apparatus of claim 2, wherein the connecting surface includes a concave-convex surface.

5. The lighting apparatus of claim 4, wherein the concave-convex surface includes a combination of at least one of a concave shape that has an inclined surface and a convex shape that has an inclined side surface.

6. The lighting apparatus of claim 1, wherein the light guide cover comprises a first light guide cover which is dome-shaped and disposed on an upper side of the mounting portion, and a second light guide cover which is tube-shaped and disposed under the mounting portion.

7. The lighting apparatus of claim 1, further comprising a reflecting portion disposed on an internal surface of the light guide cover and which reflects the light to an external surface of the light guide cover.

8. The lighting apparatus of claim 1, further comprising a heat radiating portion which radiates heat generated by the plurality of light-emitting devices.

9. The lighting apparatus of claim 8, wherein the heat radiating portion comprises a first heat radiating portion comprising:
a plurality of heat radiating fins arranged in a radial shape based on a central axis of the lighting apparatus; and
a plurality of louver fins that are cut from the plurality of heat radiating fins to bend.

10. The lighting apparatus of claim 9, wherein the heat radiating portion further comprises a second heat radiating portion which connects the first heat radiating portion and the mounting portion.

11. The lighting apparatus of claim 10, wherein a cross-section area of the second heat radiating portion contacting the mounting portion is smaller than a cross-section of the mounting portion.

12. The lighting apparatus of claim 1, further comprising a first printed circuit board (PCB) substrate which is disposed on the mounting portion and on which at least one of the plurality of light-emitting devices is disposed, wherein the first PCB substrate has a circular shape.

13. The lighting apparatus of claim 1, further comprising a second PCB substrate which is disposed under the mounting portion and on which at least one of the plurality of light-emitting devices is disposed, wherein the second PCB substrate has a ring shape.

14. The lighting apparatus of claim 1, wherein the plurality of light-emitting devices comprises a first light-emitting device and a second light-emitting device disposed adjacent to each other on a same substrate, and the first light-emitting device and the second light-emitting device are connected to each other by a metal layer coated from a portion of the first light-emitting device across a portion on the substrate to a portion of the second light-emitting device.

15. The lighting apparatus of claim 1, further comprising a transmitting cover above the light guide cover and which emits light from at least one central light-emitting device located at a center area of the mounting portion.

16. The light apparatus of claim 15, wherein the light guide cover is tube-shaped and the transmitting cover is dome-shaped.

17. The light apparatus of claim 15, wherein the transmitting cover faces the light guide cover at a position corresponding to an irradiation angle of the at least one central light-emitting device.

18. A light guide cover for guiding light emitted from a lighting apparatus to an outside, the light guide cover comprising:
an internal surface;
an external surface opposite the internal surface; and
a light-emitting device accommodating space which is provided between the internal surface and the external surface to accommodate at least one light-emitting device.

19. The light guide cover of claim 18, wherein the light-emitting device accommodating space is a groove provided in a connecting surface which connects the external surface and the internal surface.

20. The light guide cover of claim 18, wherein an upper portion of the light guide cover is dome-shaped and a lower portion of the light guide cover is tube-shaped.
